(19) United States
(12) Patent Application Publication
(10) Pub. No.: US 2016/0035055 A1
(43) Pub. Date: Feb. 4, 2016

(54) SYSTEM FOR SINGLE-USE STOCK IMAGE DESIGN

(71) Applicant: CANVA PTY LTD., Surry Hills (AU)

(72) Inventors: Melanie Perkins, Surry Hills (AU); Cliff Obrecht, Surry Hills (AU)

(21) Appl. No.: 14/777,071

(22) PCT Filed: Mar. 14, 2014
(86) PCT No.: PCT/US14/27592

§ 371 Date: Sep. 15, 2015

Related U.S. Application Data
(60) Provisional application No. 61/789,024, filed on Mar. 15, 2013.

(51) Int. Cl. G06Q 50/18; G06F 17/24

(52) U.S. Cl. CPC G06Q 50/184; G06F 17/248

(57) ABSTRACT

A single-use design element licensing system having a licensing server and a design element repository, where each design element in the repository comprises a licensing attribute.

### CROSS-REFERENCE TO RELATED APPLICATIONS

This Application claims the benefit under 35 U.S.C. §119(e) of U.S. Provisional Patent Application Ser. No. 61/789,024, filed on Mar. 15, 2013, the contents of which are incorporated herein by reference in their entirety.

### FIELD OF THE INVENTION

The present invention relates generally to the stock image design field, and more specifically to a new and useful single-use stock image design element system.

### BACKGROUND

In the graphic design process, a designer can have to search for stock graphics, purchase selected graphics, search for fonts, purchase and install the fonts, cut and prepare the stock graphics, create and design graphics in a pixel or vector based program, layout the final design before, and then send the digital file for printing or production. For the designer, this process is time consuming and requires a substantial amount of training and experience across a number of graphic design programs and websites. This increases the cost and time involved in creating design assets and can be cost prohibitive to many use cases.

Additionally, any changes in the design can require repeating of the steps, and in the case of purchasing stock graphics and fonts, redesigns can increase the cost of the final design. For the providers of the stock graphics, the process can be similarly frustrating. The stock images are often provided as royalty free licenses enabling the user to use the graphic in any number of final graphics. Thus, there is a need in the stock image design field to create a new and useful single-use stock image design element system.

### SUMMARY

The invention described herein solves the problems with the prior art by providing a single-use design element licensing system that has a licensing server and a design element repository communicatively coupled to the licensing server. Each design element in the repository has a licensing attribute to determine what the license or licenses are attached to each design element. The licensing system can also have an application server that works with the licensing server and the design element repository.

The licensing server comprises non-transitory instructions operable on a processor to cooperatively provide a single use license for each design element on a native, browser base, client side application and/or plug-in. The licensed design elements can be selected from the group consisting of images, graphics, video, flash, audio, music, animation, interactive media, multimedia and presentation according to a licensing model. The licensing model is normally a single-use license specifying restrictions and pricing for the one time use of the design element in a published design. The single-use license is persistently enforced so that each design element can be systematically enforced to comply with license pricing guidelines before the design element is published.

In certain instances, the design element can comprise multiple design elements from different content producers. In this case, the license server comprises instructions to apportion license fees for each design element used in the multiple design element, so that each part of the overall design element is licensed correctly, whether a single use license or an alternative license can be made available to the user. Some of the available alternative licenses are selected from the group consisting of a subscription license, a multiple-use license, an unlimited-use license, a creative common license and a public domain license. The licensing server can detect and track the final use of the one or more than one design element and provide licensing options to the user.

The license server can also regulate and manage publishing the design elements and the final design, where license fees can be collected for additional use of the design elements.

The license server can adjust the license price for the design element based on use attributes assigned by the design program. The attributes can be selected from the group consisting of size, time portion, scale properties, surface area, pixel area, visible portion, and obstruction. An algorithm to search for particular attributes received from the design program to can be used to provide related design elements to the user, such as, for example, lighting conditions, art style, color properties, type of graphics, perspective properties. In certain embodiments, the license server can alter the design element to match the related design element attributes.

The license server can also have an export module. The export module can be operably part of the license server, or remote from and communicatively coupled to license server. The export module converts the final design graphic to a final output by publishing a design after the usage licenses have been approved, usage fees paid, or both the usage licenses have been approved and the usage fees paid. The export module can add watermarking, advertisements, or both watermarking, and advertisements into the published design to alter the pricing and license restrictions to reduce the costs for the user.

The design element repository can be one or more than one database, such as, for example, an Internet accessible database. The application server can display a design program to the user that is used to access the design repository.

The system can also have a remote computer. The remote computer can be used to create designs and receive licenses transmitted from the licensing server for design elements transmitted from the design repository. The remote computer can also execute a third party program and a control program for accessing the design elements from within the third party program. In this embodiment, the control program receives both design elements and licensing transmitted from the licensing server and the repository, where the design elements are accessible from within the third party software without any modifications to the third party software. Alternatively, the third party program can be a plug-in module for accessing and licensing design elements, where the remote computer can be used to create designs and receive licenses transmitted from the licensing server, where the design elements are stored on the user's computer in a watermarked format, where the watermark can only be removed once a license code transmitted from the licensing server.

There is also provided a method for using single-use design element licensing system comprising the steps of a) logging onto the system of claim 1; b) selecting a design template; c) searching for one or more than one design element to include in the design; d) placing a watermarked version of the one or more than one design element into the design; and e) publishing the design. Optionally, a user can create a custom design by specifying design layout parameters. A price can be displayed for each design element returned from the search. The user can send a preview of the design for review containing one or more than one watermarked design element, where the preview can be sent using a link or an image of the design.

The step of publishing further comprises: a) determining which of the design elements are visible in the design; b) displaying a payment screen comprising a total amount for the visible design element used in the design; c) removing watermarks from the visible design elements; and d) storing a final version of the design to be download.

### BRIEF DESCRIPTION OF THE DRAWINGS

These and other features, aspects and advantages of the present invention will become better understood with regard to the following description, appended claims, and accompanying figures where:

FIG. 1 is a diagram of a single-use design element licensing system;

FIG. 2 is a flowchart diagram of an internet based single-use stock image design element system according to one embodiment;

FIG. 3 is a is a screenshot of a user login screen useful for the system of FIG. 1;

FIG. 4 is a screenshot of a temple design selection;

FIG. 5 is a screenshot of a custom design selection;

FIG. 6 is a screenshot of a design interface 600 for using one or more than one design element;

FIG. 7 is a screenshot of a design element search;

FIG. 8 is a screenshot of a design element selection;

FIG. 9 is a screenshot of information pertaining to the selected design element of FIG. 8;

FIG. 10 is a screenshot of a watermarked design element being placed in the template;

FIG. 11 is a screenshot of a review option for the watermarked design element;

FIG. 12 is a screenshot of a payment option for the selected design element to be used in the design;

FIG. 13 is a screenshot of the payment confirmation screen for a purchased single use design element;

FIG. 14 is a screenshot of a purchased design element with the watermarks removed;

FIG. 15 is a screenshot of a listing of the completed design that has been stored in a storage;

FIG. 16 is a screenshot of a payment screen for unpaid design elements used in the completed design prior to publishing the completed design and removal of watermarks from the unpaid design elements;

FIG. 17 is a screenshot of a publishing dialog box for a completed, paid design; and

FIG. 18 is a screenshot of the completed, paid design being published to a selected format.

### DETAILED DESCRIPTION

The present invention overcomes the limitations of the prior art by providing a single-use stock image design system. The system creates an integrated design process from design elements to final design use/export, where design elements can be fully monitored and licenses are enforced at the export/publishing stage. By maintaining and modeling the objects used in a design, the system provides powerful licensing options that can enforce pricing and usage restrictions on design elements while making the design elements more widely available to users.

The system is mutually beneficial to designers and to content providers of design elements. Designers have access to a wider variety of design elements and only pay for the design elements that are actually used in the design. Additionally, design elements can be prices for the manner of design that the design elements are used. The system comprises intelligent object/design elements used in designs. Additional object intelligence can improve design element discovery, automatic adjustment of design elements to match a design vision, and ease of use. The system maintains design elements as resource objects and avoids allowing the resource objects to degenerate into raw pixels or vectors where control over the design elements ownership can be lost. Simultaneously, providers of design elements are provided with a design ecosystem/platform that integrates a mechanism capable of enforcing a single-use licensing model. Resource control can be enforced so that the providers are credited for each use of the design element and in some cases providers can control the manner that the design element are used.

A design platform can be provided for users to create designs using design elements from the system and other user supplied images, such as, for example, uploaded images. The design platform can be accessible through a web browser and/or a native application on the user's computer or mobile device. Once finished, the user selects to export/publish their design to a particular medium (e.g., digital file, publish to a website, print to physical medium, etc.), and then pays for the design elements used. Once payment has been received, the watermarks are removed and the design is delivered to the user or otherwise published. The content owners of the design assets used will receive the appropriate compensation for the use of design elements used.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments can be practiced without these specific detail. Well-known structures and techniques can not be shown in detail in order not to obscure the embodiments. For example, algorithms can be shown in block diagrams in order not to obscure the embodiments in unnecessary detail.

Also, it is noted that the embodiments can be described as a process that is depicted as a flowchart, a flow diagram, a structure diagram, or a block diagram. Although a flowchart can describe the operations as a sequential process, many of the operations can be performed in parallel or concurrently. In addition, the order of the operations can be rearranged. A process is terminated when its operations are completed. A process can correspond to a method, a function, a procedure, a subroutine, a subprogram, etc. When a process corresponds to a function, its termination corresponds to a return of the function to the calling function or the main function.

Moreover, a storage can represent one or more devices for storing data, including read-only memory (ROM), random access memory (RAM), magnetic disk storage mediums, optical storage mediums, flash memory devices and/or other machine readable mediums for storing information, such as, for example a database. The term “machine readable medium” includes, but is not limited to portable or fixed storage devices, optical storage devices, wireless channels and various other mediums capable of storing, containing or carrying instruction(s) and/or data.

Furthermore, embodiments can be implemented by hardware, software, firmware, middleware, microcode, or a combination thereof. When implemented in software, firmware, middleware or microcode, the program code or code segments to perform the necessary tasks can be stored in a machine-readable medium such as a storage medium or other storage(s). One or more than one processor can perform the necessary tasks in series, distributed, concurrently or in parallel. A code segment can represent a procedure, a function, a subprogram, a program, a routine, a subroutine, a module, a software package, a class, or a combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted through a suitable means including memory sharing, message passing, token passing, network transmission, etc.

In the following description, certain terminology is used to describe certain features of one or more embodiments of the invention.

The term “design element” refers to any current or future multimedia files, design elements or objects including images, clip art, video and audio, fonts, design layouts, layouts that have several design elements from different content producers, text layouts, graphic templates, graphic files, photos, illustrations, vector graphics, icons, symbols, text layouts, graphic layouts, patterns and textures, 2D and 3D models, models with a kinetic model (e.g., a 2d or 3D model of a person that can be positioned into a variety of poses) and design effects.

The term “mobile device” refers to smart phones, tablets and other mobile devices that comprise the ability to interact with the internet.

The term “plug-in” refers to plug-in a software component that adds a specific feature to an existing software application.

The term “publish” refers to finalizing a design containing design elements by saving the design, exporting the design to another format, creating an electric copy in a secure format, creating a web compatible version of the design, printing the design, downloading a copy, or any other method for completing the design project contemplated now or in the future.

Various embodiments provide a system for a single-use stock image design. In another embodiment, there is provided a method for using the system. The system and method will now be disclosed in detail.

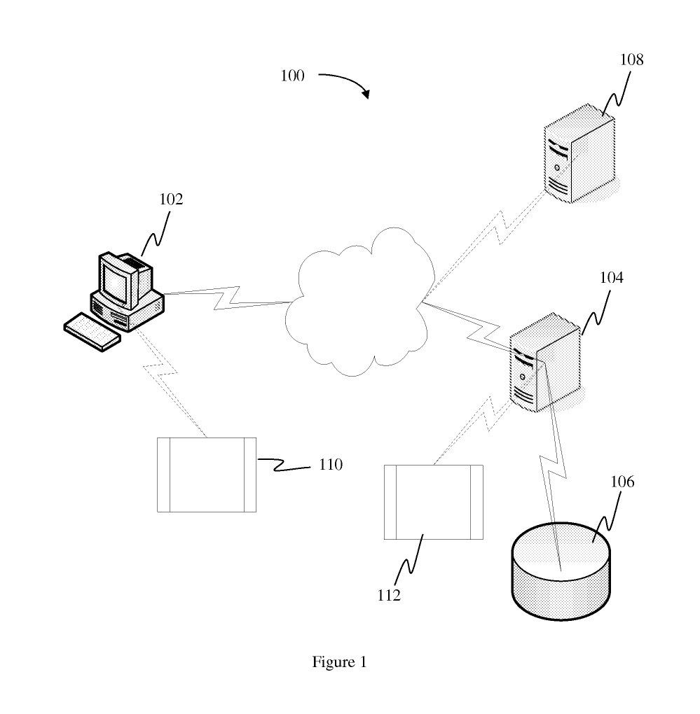

Referring now to FIG. 1, there is shown a diagram of a single-use design element licensing system 100 according to one embodiment. The system 100 comprises a user's computer 102, a licensing server 104 and a design element database 106 or repository. In a preferred embodiment, a user accesses non-transitory instructions executable on the user's computer from an application server 108. The application server presents the user with a design program used to access the design element database 106. In another embodiment, the user's computer can comprise non-transitory instructions to create designs and receive licenses from the licensing server 104 for design elements received from the design element database 106. Optionally, the user can use a third party program, such as, for example, Adobe® Photoshop® or Adobe® Illustrator® and a control program 110 for accessing the design elements from within the third party programs. The control program 110 will receive both design elements and licensing from the licensing server 104 and the repository 106 and the design elements will be accessible from within the third party software without any modifications to the third party software. Alternatively, plugin modules for third party software comprising non-transitory instructions for accessing and licensing design elements can also be created. Also, the user's computer can comprise non-transitory instructions to create designs and receive licenses from the licensing server 104, but the design elements are stored on the user's computer 102 in a watermarked format, where the watermark can only be removed once a license code is entered by the user.

Using any of the system 100 options above, the user can create design and experiment with different layouts and other options without having to purchase all the design elements, including many that will not be used. Using the system 100, user's can be more creative without fear of going over budget, or being restricted to a single stock image repository that has been purchased. Additionally, content creators of the design elements will have a better means of having their content used and licensed properly.

The system 100 is a design platform served from a distributed computing system, a computing cluster, a server, or any suitable computing server infrastructure. The system can additionally be cooperatively implemented with a portion of components operational on a native or client side application or plug-in. The system is applied towards the creation of graphical design assets, but the system can additionally or alternatively be applied to video, flash, audio, music, animation, interactive media, presentation, and/or any suitable design medium.

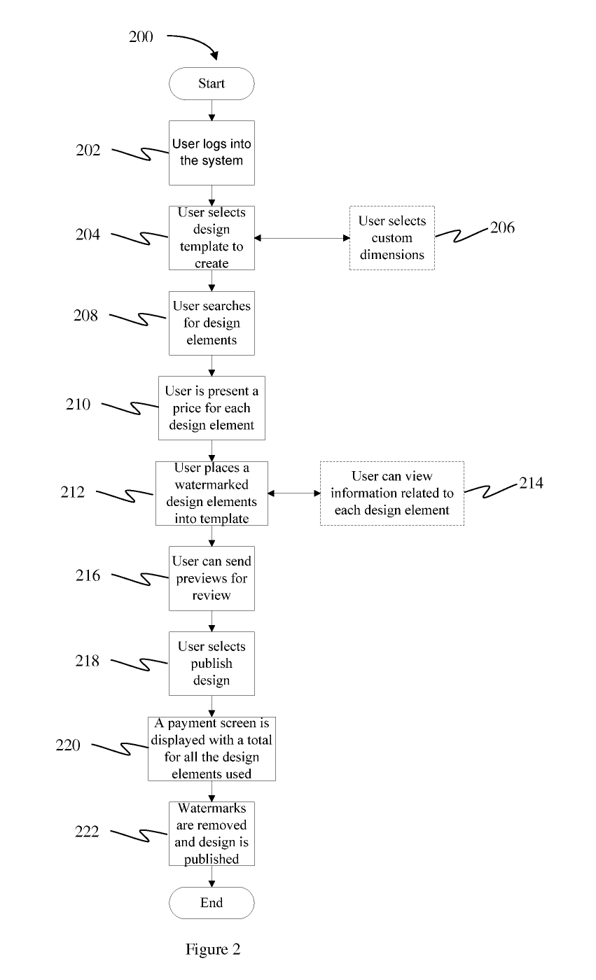

Referring now to FIG. 2, there is shown a flowchart diagram 200 of a system for an internet based single-use stock image design according to one embodiment. First, a user logs 202 onto the system 100. Then, the user selects a design template 204. Alternatively, the user can create a custom design 206. Next, the user can search 208 for one or more than one design element to include in the design. Once the search is complete, the user is presented with a price 210 for each design element. Prior to purchasing the one or more than one selected design element, the use can place a watermarked version 212 of the one or more than one design element into the design. Then, the user can send the previews 216 of the design for review containing the one or more than one watermarked design element. Next, when the design is approved or the user is satisfied with the design, the user can publish the design 218. Then, a payment screen is displayed 220 comprising a total amount for the one or more than one design elements used in the design. Next, the watermarks on the one or more than one design element is removed and a final version of the design is available for the user to download.

Design elements are preferably stored in an Internet accessible database or repository 106. One or more than one design element can have a licensing model attributed to it. Preferably, the licensing model is a single-use license specifying restrictions and pricing for the one time use of the design element in an exported design asset. The single-use license is persistently enforced in the design platform so that each design element can be systematically enforced to comply with license pricing guidelines before the design element is published in the final output. Some variations can additionally act to enforce outside design element restrictions such as restricting the export format or add digital content management. A portion or all of the design elements can alternatively be free to use. For example, some basic design elements such as basic shapes, arrows, or text boxes can be created to seed the repository with basic stock resources. An owner of the free content can be compensated for providing the free material (e.g., monetary, credit, perks, or other compensation) for each free design element published or used.

Some design elements can comprise multiple design elements from different content producers. In this instance, the design element will have multiple owners and each element of the larger design element will be licensed and tracked by the system 100. For example, a content provider can create and make available to the system 100 a beach design element that includes separately licensable design elements including a beach, a beach ball, and sandcastle. Use of this published design element is subject to the licensing terms and pricing for each of the owners of the beach, beach ball, and sandcastle stock resources. Alternatively, other forms of licenses can be made available by the system 100, such as, for example, a subscription license, multiple-use licenses, unlimited-use licenses, or any suitable license. The system 100 and the licensing server 104 will detect and track the final use of a design element allowing for a wide variety of licensing options that are not possible currently.

The license server 104 also comprises instructions to regulate and manage the export/publishing process. The license server 104 can additionally function to regulate the use of published design elements. As described above, a user can use design elements freely while creating their customized design. The license server 104, in combination with a design interface 600 on the user's computer 102 and the repository 106 of design assets, can enable the use of single-use licenses, where design resources are licensed based on their use in the final design. The current state of the design canvas is passed through the license server 104 during an export process to create a final design asset. The license server 104 accounts for the design elements used and the price based on the manner of use within the design. The license server 104 can set the price of the design element based on various attributes. The attributes can be size (e.g., for graphics), time portion (e.g., for music and video), or other suitable scale properties. In one embodiment, design element pricing can be based on the surface area (or pixel area) visible in the published design. In another embodiment, if a design element is active in the design canvas but is fully obstructed by one or more design elements in the foreground (e.g., the user can have forgotten about that resource), then the user will not be charged for use of that design element.

The license server 104 can comprise non-transitory instructions executable on a processor for an export module. The export module 112 can be part of the license server 104 or be a separate component that operates in cooperation with the design interface 600 and the license server 104. The export module 112 converts the final design to a final output. The export module 112 only exports a file after the usage licenses have been approved and/or the usage fees have been paid. In one variation, the exported design element is delivered as a digital file.

An original or composite design element can be added to a market place for others to purchase. In yet another variation, the design element can be added to the repository of stock resources enabling other users to build off of the designs. The combination of design elements used can continue to be licensed even if the user has added a design element resource (as opposed to individually selecting the stock resources). The export module 112 of the license server 104 can additionally add watermarking and/or advertisements into the exported design that can be used to offset or alter the pricing and license restrictions. The export module 112 can additionally directly deliver a final design asset for physical production. The export module 112 can provide the capability to order: flyers, prints, posters, business cards, apparel, books, boxes, and other suitable content with at least one design element applied to the item.

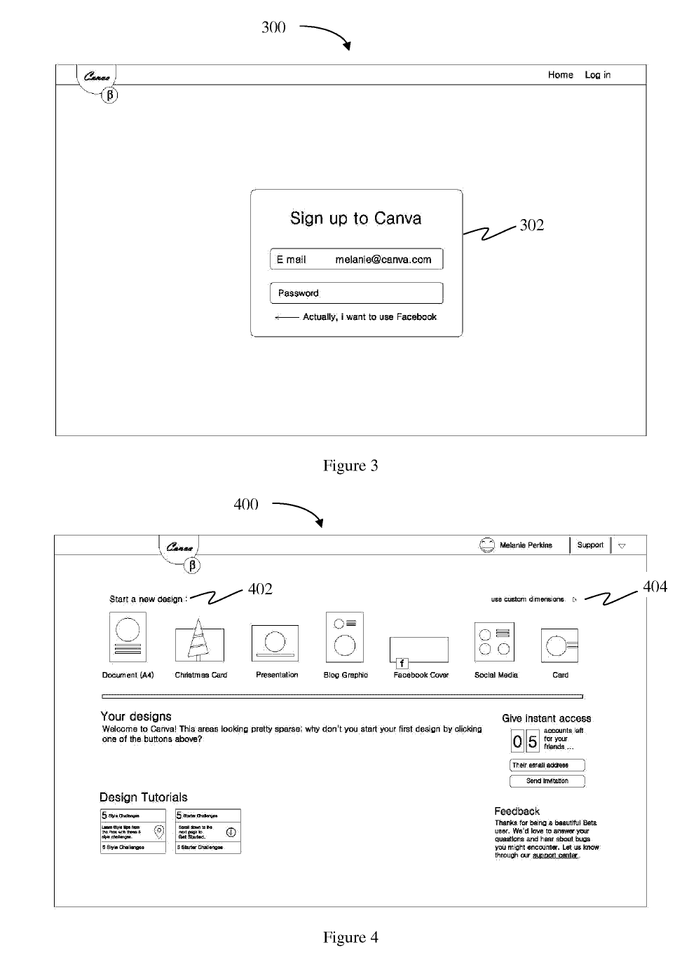

Referring now to FIG. 3, there is shown a screenshot of a user login screen useful for the system of FIG. 1. As can be seen in this embodiment, a user enters a registered email address and a password to access the system 100. Optionally, other login methods can be used, such as, for example, Facebook®, Google® or Twitter® login information can be used.

Referring now to FIG. 4, there is shown a screenshot of a temple design selection 400. After logging into the system 100, the user is presented with a user interface for selecting a new design template, a custom design template or a previously stored design. The previously stored designs can be completed works to be published again, along with an additional license fee, or the stored design can be edited.

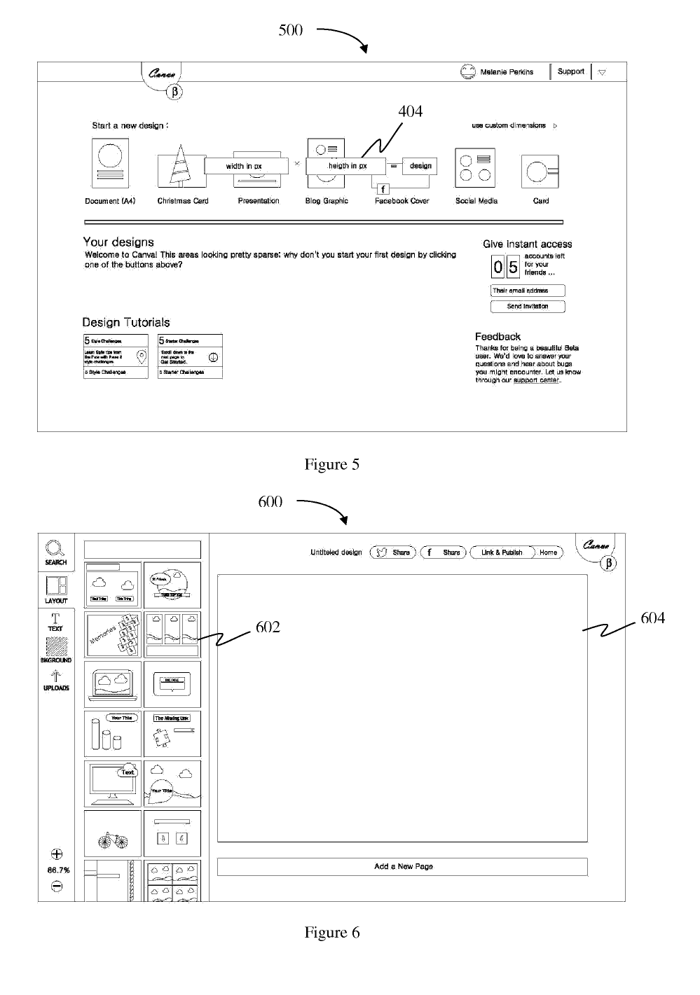

Referring now to FIG. 5, there is shown a screenshot of a custom design selection 500. The user can select custom dimensions, by selecting the appropriate item in the user interface. In this embodiment, the custom design is selected by selecting ‘Use Custom Dimensions’. A pop-up dialog box appears so that the user can input the dimensions 502, such as height and width, of the custom design.

Referring now to FIG. 6, there is shown a screenshot of a design interface 600 for using one or more than one design element 602. The design interface 600 can be interactively coupled to the repository 106 that includes a search module 702 and a design canvas 604.

The design interface 600 can manipulate design elements 602 (e.g., stock graphics, video, 3D object models and the like) to simplify the design process for the user and to enable support for single use or one-time licensing. The repository 106 of prepared design elements 602 comprises a plurality of design resources. Additional design elements can be interfaced to the design interface 600 from an outside resource or outside repository from a third party and can be integrated into the system 100.

The design elements 602 are prepared for use in a design canvas 604. For graphic resources, the design elements 602 only consist of a single object or a group of objects. In practice, stock graphics lack backgrounds or background images and are configured for an alpha channel of the graphic other than for the graphic of the object to be transparent. Some design elements 602 can include semi-transparent settings such as a stock graphic of sunglasses or of a window. Since the design element 602 is an object, perspective, lighting, material properties, colors, styling, rendering effects, and other properties can change when used in a design.

The design interface 600 can be used for creating a design using the design elements 602 of the repository 106. Preferably, the design interface 600 primarily relies on a drag and drop design interaction, where resources from the repository 106 are used in combination to create customized designs. However, as will be appreciated by those with skill in the art with reference to this disclosure, design elements can be placed using other methods, such as, for example selecting a design element 602 from a textual search and indicating the coordinates on the design canvas 604 without dragging and dropping the design element 602, or by selecting the design which will then be placed on the design canvas 604 for manipulation by the user. The design interface 600 can be interactively coupled to the repository 106.

While the design interface 600 and the use of design elements 602 lowers the barriers to creating designs for novice designers, the design interface 600 can optionally include a one or more than one dynamic and controllable design elements 602 and more advanced design tools to provide advanced users with greater customization and creative capabilities. The design interface 600 can include other design tools, such as a text tool or simple vector drawing tools. As can be appreciated, a one time use or rental period as described herein can be used for design tools as well as design elements. Expensive or rarely used design tools can be licensed for a single use or for a period of time lessening the purchase burden on the end user while still providing income to the tools creators.

The design interface 600 can comprise non-transitory instructions operable on a processor to implement the design interface 600 as a client application accessible from an Internet browser or a native application operable on a desktop computer, a smart phone, a tablet computer, or any suitable computing device. Because a preferred embodiment of the design interface 600 uses existing stock resources, the design interface 600 is particularly well suited for touch interfaces commonly found on mobile devices. The design interface 600 of the above embodiment requires an active network connection to access the repository of stock resources and other tools of the design interface 600. Alternatively, all or a subset of the design elements 602 can be cached or locally stored for use without an internet connection.

The design canvas 604 is a design document or sandbox for creating the design. For graphical assets the design canvas 604 can be a rectangular document as is commonly encountered with graphic design programs. However, the shape of the design canvas 604 can be any suitable shape. The design canvas 604 can have background parameters such as, for example, a background color, a gradient or a graphic. Alternatively, the background can be transparent. In a video or audio implementation, the design canvas 604 can be a timeline based design canvas 604 commonly used in audio/visual design programs. The design canvas 604 is configured to receive stock resources. The design elements 602 can be positioned, rotated, transformed, arranged, aligned, grouped, scaled, patterned, edited, duplicated, mirrored, masked, augmented, or modified in any suitable manner on the design canvas 604. The design elements 602 can additionally interact with other design elements 602 within the design canvas 604, such as altering lighting conditions, matching art styles, changing perspectives, casting shadows, or interacting in any suitable manner. The design canvas 604 can include a persistent water mark or other augmentations of the design element to prevent improper duplication of the design process without exporting or publishing the design element through the license server 104.

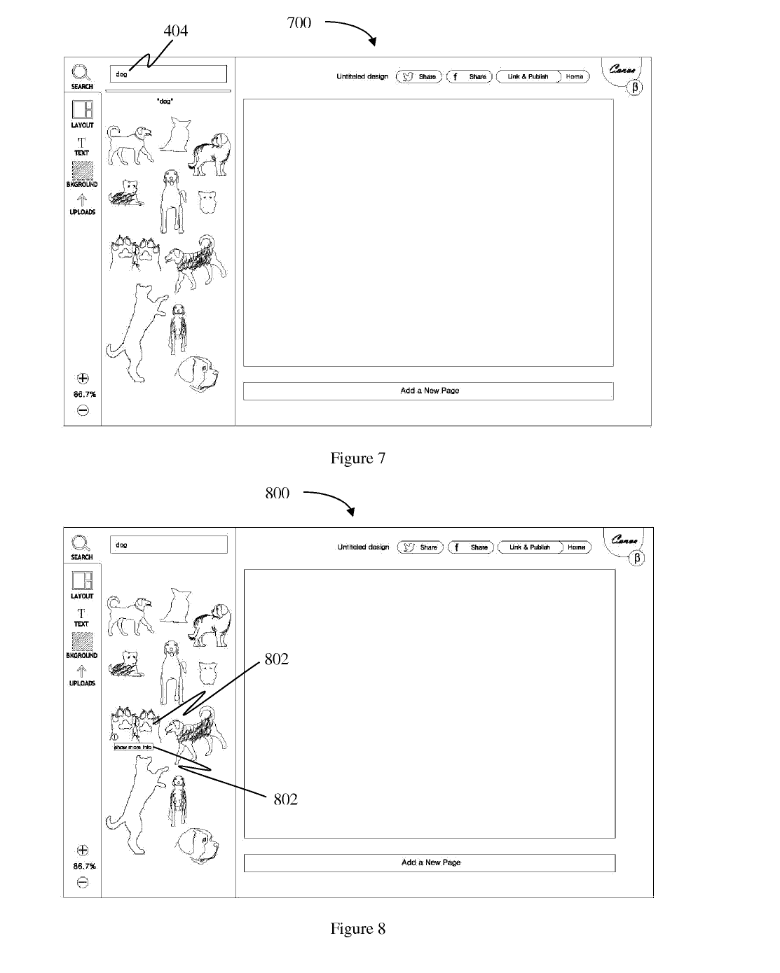

Referring now to FIG. 7, there is shown a screenshot of a design element search 700. As can be seen the design element search module 702 can be used to search for a particular set or subset of design elements 602. Preferably, the search module 702 is a browser interface for stock resources. The search module 702 provides access to at least a subset of design elements 602 stored in the repository 106. The search module 702 can instructions to include basic search and/or content navigation functionality. The search module 702 receives a search query and returns resources that match that query. Optionally, the search module 702 comprises instructions for additional search parameters, such as sorting by popularity, rating, relevance, color, categorization, etc. The search results 704 are displayed as design elements 602 that can be added to the design canvas 604. In a preferred embodiment, the search module 702 comprises instruction for an adaptive search to provide highly relevant, appropriate, and adaptive search results 704 to the user. The search module 702 can use the active design elements 602 currently in the design canvas 604 to augment a search query. For example, if the user searches for “tree,” and the design canvas 604 includes several design elements 602 with a “Christmas” tag, then the search module 702 can provide search results 704 that include design elements 602 with the tag “Christmas tree” since the user likely has a Christmas themed design. The search module can use an algorithm to search for particular attributes received from the design canvas 604 to provide related design elements 602 to the user. The attributes can comprise lighting conditions, art style, color properties, type of graphics (e.g., photos, vector image, computer graphics), perspective properties, and other suitable resource properties to return substantially consistent search results 704. For example, if the design elements 602 actively used on the design canvas 604 are vector art with a cartoon style, the search module 702 can return similar vector art with a cartoon style even if the search query didn't specify these search parameters. This simplifies the process of searching for matching design elements 602 to give the final design a cohesive and consistent aesthetic. Also, resource properties of active design elements 602 can be used by the search module 702 to cause automatically augment the search results 704. For example, line color, thickness, and style of the search results 704 can be altered to match the active design elements 602 on the design canvas 604. Similarly, the search module 702 can automatically augment the design elements 602 to match the search results 704. For example, a vector-based design element 602 can originally be a red kite. If the user searches for “yellow kite” the color of the red kite design element can be dynamically changed to yellow and returned as a search result 704 to match the users search query. The search module 702 can include a historical stream of search results 704, so that the user can quickly scroll through previous search results 704. The search module 702 can additionally include recently used, favorite, recommended, promoted, popular, and/or automatically selected design elements 602.

Referring now to FIG. 8, there is shown a screenshot of a design element selection 800. As can be seen, once the user receives a search result 704 or selects a design element 602, the user can select one or more than one design element 802. Once the selected design element 802 is chosen by the use an additional information box 804 is displayed.

Referring now to FIG. 9, there is shown a screenshot of information pertaining to the selected design element of FIG. 8. If the user selects the additional information box 804, all the available information 902 pertaining to the selected design element 802 is displayed. In some cases the available information 902 is displayed below the selected design element 802 in other instances a separate information screen (not shown) can be displayed if the quantity of information regarding the selected design element 802 is larger than the available area in the design interface 600. The available information 902 can be stored with the design element 902 in the repository 106 or in third party repositories for external design elements 602.

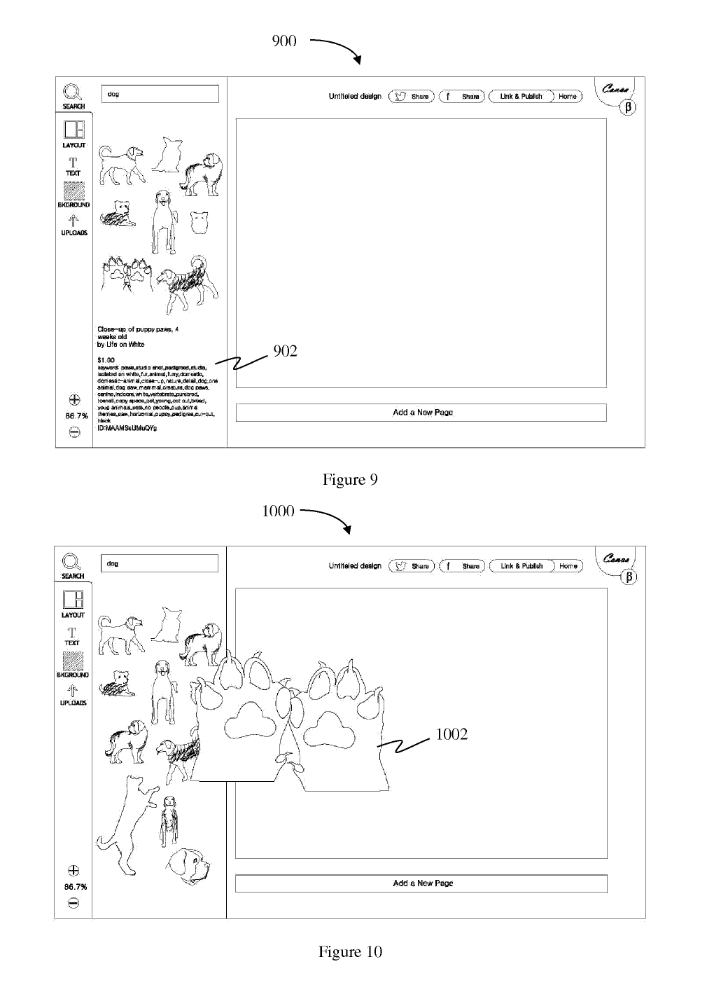

Referring now to FIG. 10, there is shown a screenshot 1000 of a watermarked design element 1002 being placed in the template. As can be seen, the watermarked design element 1002 is dragged from the search module 702 and placed on the design canvas 604. Then the user can manipulate the watermarked design element 1002 until the design is completed. The watermarked design element 1002 can be positioned, rotated, transformed, arranged, aligned, grouped, scaled, patterned, edited, duplicated, mirrored, masked, augmented, or modified in any suitable manner on the design canvas 604.

Adding a second design element 602 to the design canvas 604 can augment at least one additional design element according to the second design element 602 attributes. The attributes can enable automatic interactions between design elements 602 when added to the design canvas 604. Preferably, a design element placeholder can be used to allow the user to add a second design element to the placeholder image. The second design element can be incorporated into the first design element applying any characteristics or attributes of the design element placeholder.

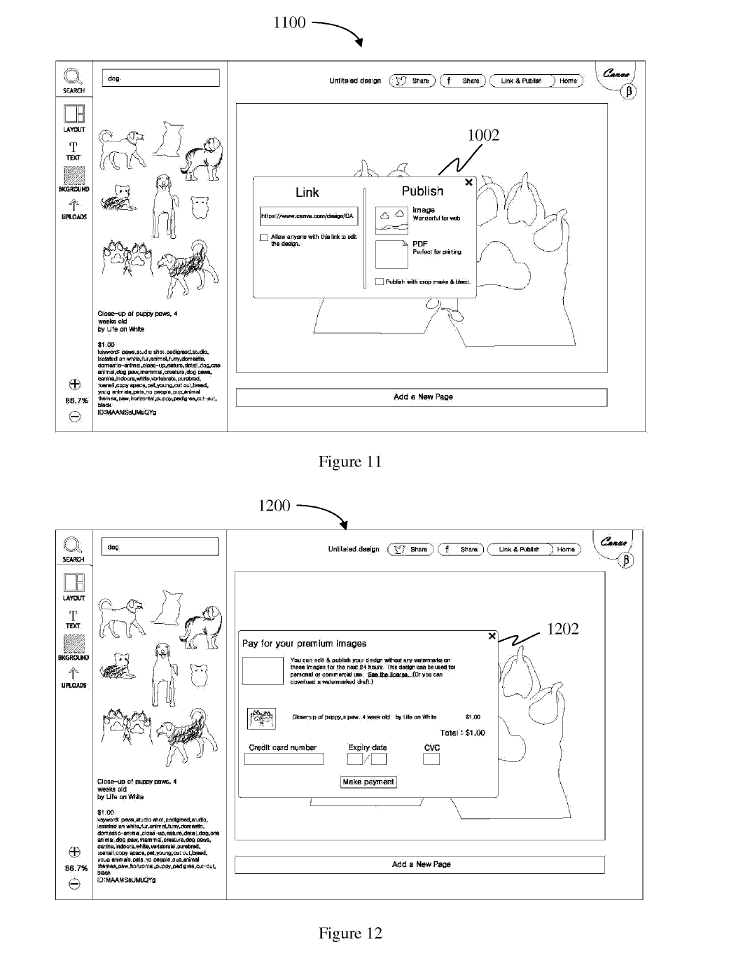

Referring now to FIG. 11, there is shown a screenshot of a review option 1100 for the watermarked design element 1002. Once the user has selected the watermarked design element 1002, but prior to publishing or exporting the design, the user can send the watermarked design element 1002 for review. In this embodiment, the user can select “Link and Publish” to send a link 1104 to another to ‘view’ or ‘edit.’ Alternatively, the user can download the watermarked design element 1002 as an image 1106 or PDF 1108. If the user is downloading the watermarked design element 1002 as a PDF the user can choose to include crop marks and bleed 1110. The downloaded watermarked design element 1002 can then be sent for review using traditional means, such as email or hardcopy.

Referring now to FIG. 12, there is shown a screenshot of a payment option 1200 for the selected design element to be used in the design. Once the user has decided to publish the watermarked design element 1002, a purchase option dialog box 1202 is shown to enter payment for any premium design elements 602 used. The user can enter the appropriate payment information into the purchase option dialog box 1202. In a preferred embodiment, the purchase option dialog box 1202 accepts a credit card. Other alternative payment gateways can also be used, including deposit accounts that can display funds available to purchase design elements 602. Also, the user's payment information can be securely stored in the system 100 so that the user can view and update the information as needed.

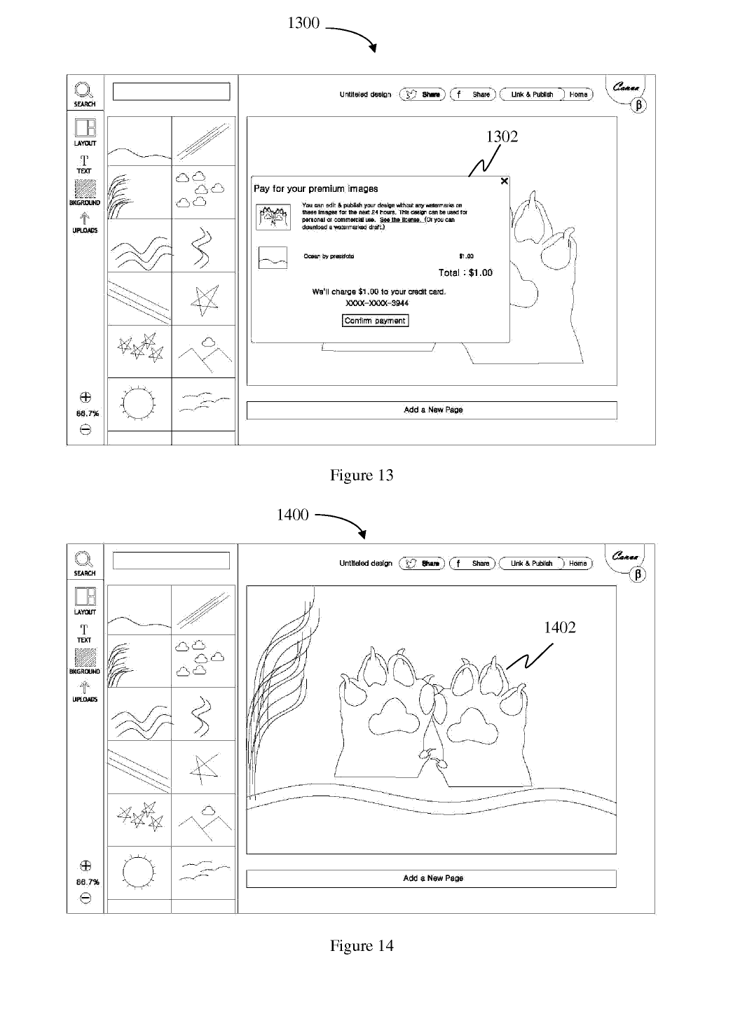

Referring now to FIG. 13, there is shown a screenshot 1300 of a payment confirmation screen 1302 for a purchased single use design element. As can be seen, extra security can be provided by a secondary payment confirmation screen 1302 to insure that the user did not accidentally select the purchase option. Once a confirmation of payment is received, the system 100 issues a single use license from the license server 104 and removes all watermarks for visible design elements.

Referring now to FIG. 14, there is shown a screenshot 1400 of a purchased design element 1402 with the watermarks removed. Once the single use license for the design element 1402 has been purchased, the design element 1402 is downloaded to user for use in the design. In another embodiment, un-watermarked versions of the design elements 1402 are not shown in the design, whether purchased or not, until the design is published.

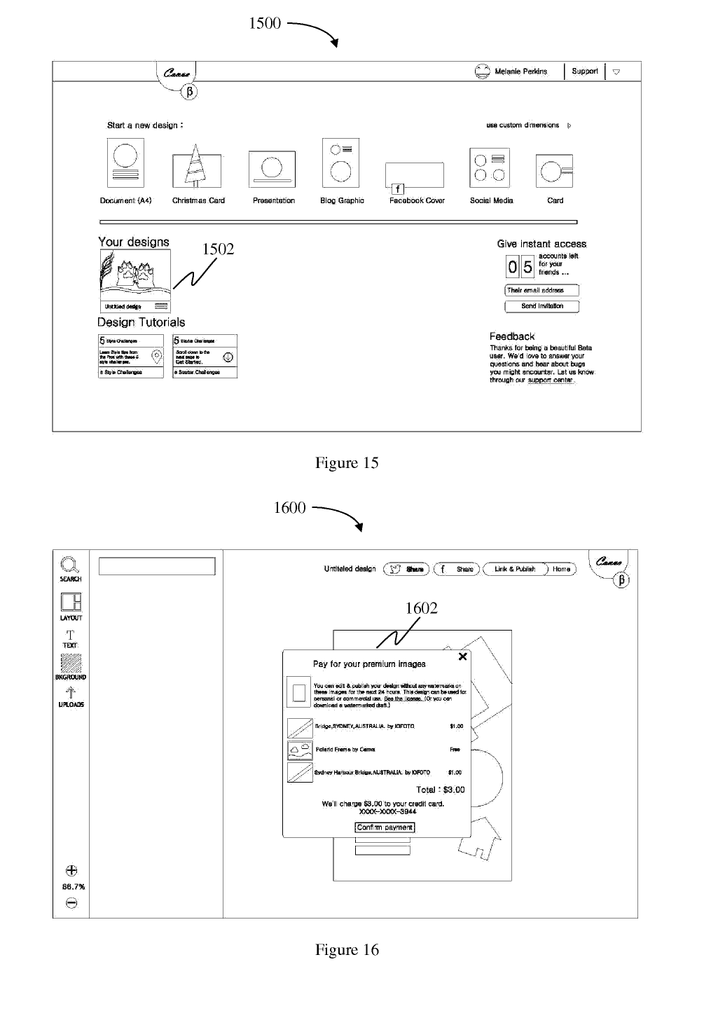

Referring now to FIG. 15, there is shown a screenshot of a listing of the completed design that has been stored in a storage. Once the purchase has been completed, the design is shown on the user interface 400, along with any other completed design, or designs in progress. The user can select from the listed designs 1502 or select a new design. This is advantageous because the user does not have to wait for final approvals, in some cases, to continue work. Once approvals are received by the user, the user can then open an existing design to continue working.

Referring now to FIG. 16, there is shown a screenshot of a payment screen for unpaid design elements 602 used in the completed design prior to publishing the completed design and removal of watermarks from the unpaid design elements. After the user receives approval of a completed design, any unpaid design elements are calculated prior to publishing the design. A publishing payment screen can be displayed showing either all the paid for design elements, unpaid design elements or both paid for design elements and unpaid design elements. Once the user has the information, the design can be altered prior to publishing, or edited to remove design elements to reduce costs if there is a budget overrun.

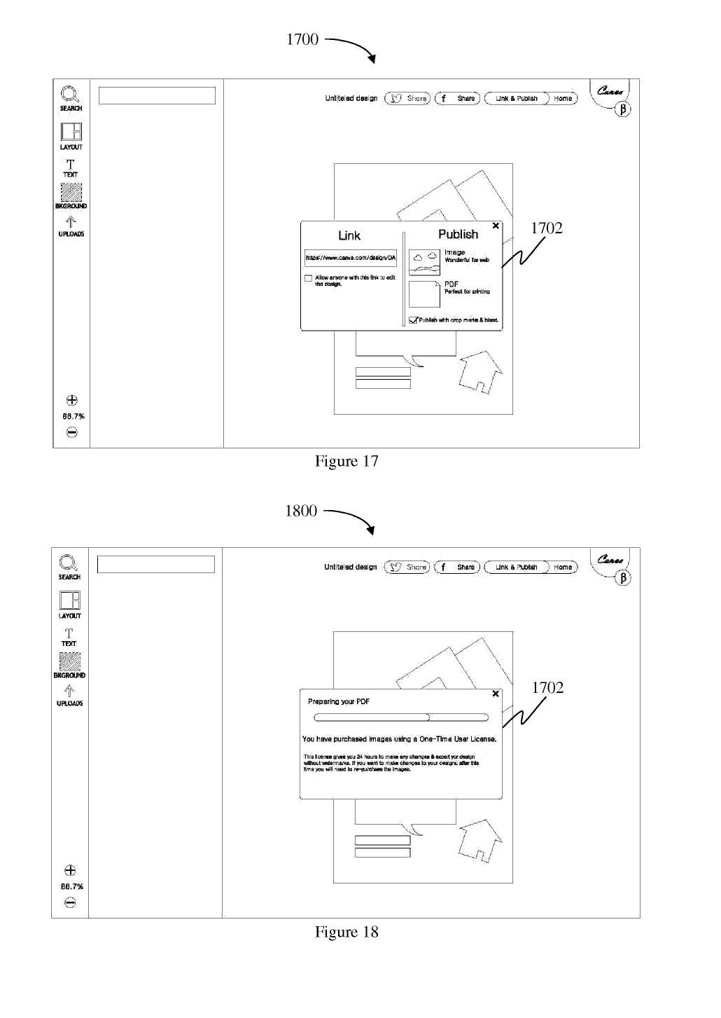

Referring now to FIG. 17, there is shown a screenshot 1700 of a publishing dialog box 1702 for a completed, paid design. Once all the payments have been received the user can publish the design in a similar fashion to the purchase of a watermarked design element 1002 above.

Referring now to FIG. 18, there is shown a screenshot 1800 of the completed, paid design being published to a selected format 1802. In this example, the selected format is a PDF with single use license restrictions applied, such as, no copying. As can be appreciated, there are other secure formats for publishing design elements 602, and the example shown is not meant to be limiting.

What has been described is a new and improved system for a single-use stock image design, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, can be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A single-use design element licensing system, the system comprising:
a) a licensing server; and
b) a design element repository communicatively coupled to the licensing server, where each design element in the repository comprises a licensing attribute.

2. The system of claim 1, where the licensing system further comprises an application server communicatively coupled to the licensing server and the design element repository.

3. The system of claim 1, where the licensing server comprises non-transitory instructions operable on a processor to cooperatively provide a single use license for each design element on a native, browser base, client side application and plug-in.

4. The system of claim 1, where the licensing server can license design elements selected from the group consisting of images, graphics, video, flash, audio, music, animation, interactive media, multimedia and presentation.

5. The system of claim 1, where the one or more than one design element can have a licensing model.

6. The system of claim 5, where the licensing model is a single-use license specifying restrictions and pricing for the one time use of the design element in a published design.

7. The system of claim 6, where the single-use license is persistently enforced so that each design element can be systematically enforced to comply with license pricing guidelines before the design element is published.

8. The system of claim 1, where the one or more than one design element can comprise multiple design elements from different content producers.

9. The system of claim 8, where the license server comprises instructions to apportion license fees for each design element used in the multiple design element.

10. The system of claim 5, where an alternative license can be made available.

11. The system of claim 10, where the alternative license is selected from the group consisting of a subscription license, a multiple-use license, an unlimited-use license, a creative common license and a public domain license.

12. The system of claim 1, where the licensing server comprises non-transitory instructions to detect and track the final use of the one or more than one design element to provide licensing options.

13. The system of claim 1, where the license server comprises instructions to regulate and manage publishing the one or more than one design elements and the final design.

14. The system of claim 1, where the license server comprises instructions to regulate the use of published design elements, where license fees can be collected for additional use of the one or more than one design elements.

15. The system of claim 1, where the license server comprises instructions to adjust the license price for the one or more than one design element based on use attributes assigned by the design program.

16. The system of claim 15, where the attributes can be selected from the group consisting of size, time portion, scale properties, surface area, pixel area, visible portion, and obstruction.

17. The system of claim 15, where the license server comprises instructions for an algorithm to search for particular attributes received from the design program to provide related design elements to the user.

18. The system of claim 17, where the related design element attributes can be selected from the group consisting of lighting conditions, art style, color properties, type of graphics, perspective properties.

19. The system of claim 18, where the license server comprises non-transitory instructions operable on a processor to alter the design element to match the related design element attributes used in the design program.

20. The system of claim 1, where the license server further comprises non-transitory instructions executable on a processor for an export module.

21. The system of claim 20, where the export module is operably part of the license server.

22. The system of claim 20, where the export module is remote from and communicatively coupled to license server.

23. The system of claim 20, where the export module comprises non-transitory instructions to convert the final design graphic to a final output.

24. The system of claim 20, where the export module comprises non-transitory instructions to publish a design after the usage licenses have been approved, usage fees paid, or both the usage licenses have been approved and the usage fees paid.

25. The system of claim 20, where the export module comprises non-transitory instructions to add watermarking, advertisements, or both watermarking, and advertisements into the published design to alter the pricing and license restrictions.

26. The system of claim 1, where the design element repository is one or more than one database.

27. The system of claim 1, where the design element repository is an Internet accessible database.

28. The system of claim 2, where the application server comprises non-transitory instructions operable on a processor for a design program used to access the design repository.

29. The system of claim 1, further comprising a remote computer.

30. The system of claim 29, where the remote computer can comprise non-transitory instructions to create designs and receive licenses transmitted from the licensing server for design elements transmitted from the design repository.

31. The system of claim 29, where the remote computer executes a third party program and a control program for accessing the design elements from within the third party program.

32. The system of claim 31, where the control program receives both design elements and licensing transmitted from the licensing server and the repository, where the design elements are accessible from within the third party software without any modifications to the third party software.

33. The system of claim 31, where the third party program comprises non-transitory instructions for a plug-in module for accessing and licensing design elements.

34. The system of claim 29, where the remote computer can comprise non-transitory instructions to create designs and receive licenses transmitted from the licensing server, where the design elements are stored on the user's computer in a watermarked format, where the watermark can only be removed once a license code transmitted from the licensing server.

35. A method for using single-use design element licensing system, the method comprising the steps of:
a) logging onto the system of claim 1;
b) selecting a design template;
c) searching for one or more than one design element to include in the design;
d) placing a watermarked version of the one or more than one design element into the design; and
e) publishing the design.

36. The method of claim 35, where a user can optionally create a custom design by specifying design layout parameters.

37. The method of claim 35, further comprising the step of displaying a price for each design element returned from the search.

38. The method of claim 35, further comprising the step of sending a preview of the design for review containing one or more than one watermarked design element.

39. The method of claim 38, where the preview can be sent using a link or an image of the design.

40. The method of claim 35, where the step of publishing further comprising the steps of:
a) determining which of the design elements are visible in the design;
b) displaying a payment screen comprising a total amount for the visible design element used in the design;
c) removing watermarks from the visible design elements; and
d) storing a final version of the design to be download.
